(19) United States
(12) Patent Application Publication
(10) Pub. No.: US 2005/0258609 A1
(43) Pub. Date: Nov. 24, 2005

(54) Snow scooter

(76) Inventor: Tzong In Yeh, Fremont, CA (US)

Correspondence Address: CHARLES C.H. WU, 98 DISCOVERY, IRVINE, CA, 92618-3105, US

(21) Appl. No.: 11/108,447

(22) Filed: Apr. 18, 2005

(30) Foreign Application Priority Data
May 24, 2004 (TW) 093208133

(51) Int. Cl. B62B 17/00

(52) U.S. Cl. 280/14.27

(57) ABSTRACT

The present invention relates to a snow scooter, which includes a main board and a brake member. The main board is provided for a user standing thereon and the brake member is connected to a rear portion of the main board in a movable and swingable manner. Furthermore, the brake member has a shovel portion formed on under the brake member and the shovel portion has at least one opening formed thereon for expelling the snow shoveled by the shovel portion. When the brake member is pressed to snowground for braking, the snow gathered and shoveled by the shovel portion of the brake member is expelled and sprayed via the opening, so as to provide a special effect during braking.

### BACKGROUND OF THE INVENTION

(1) Field of the Invention

The invention relates to the technical field of snow scooters or main boards, and more particularly to a snow scooter which is able to spray snow from its rear portion during braking.

(2) Description of the Prior Art

Generally, a prior art snow scooter as disclosed in Taiwan publication No. 493,465, No. 530,682 or No. 532,201 includes a main board having a handlebar formed on one end of the main board and a brake member formed on the other end of the main board. The handlebar is provided for a user grabbing at and the brake member is provided for decelerating or braking the snow scooter. The brake member disclosed in Taiwan publication No. 530,682 is a baffle pivotally connected to the rear end of the main board, which is able to swing an angle when the brake member is pedaled. A pedal is provided on the baffle for a user stepping on so as to the user can apply downward pressure to the pedal to control the swinging angle of the baffle to increase the resistance to the ground or the snow and thus to decelerate or to stop the snow scooter. The brake member of the snow scooter disclosed in Taiwan publication No. 493,465 or No. 532,201 is described as follows, which is more complicated. A stem is arranged on the rear end of the snow scooter and the stem is able to move elastically and vertically. In addition, a brake plate leans against one end of the stem. In this manner, if the brake plate is stepped downward, the stem will simultaneously move downward and insert into the snow to stop the snow scooter.

Obviously, there is still a need for improving the existing functions of the brake member of prior art snow scooters.

### SUMMARY OF THE INVENTION

Accordingly, it is one object of the present invention to provide a novel snow scooter with a specially designed brake member, which is able to spray a plurality of streams of snow during brake so as to provide a special visual effect.

More particularly, the present snow scooter includes a main board and a brake member. The main board has a front portion and a rear portion and the front portion is toward a sliding direction. The brake member is connected to the rear portion of the main board and is movable and swingable to snowground flexibly. In addition, the brake member has a shovel portion formed under the brake member and the shovel portion has at least one opening formed thereon for expelling the snow shoveled and gathered by the shovel portion of the brake member.

Therefore, when the brake member is pressed into the snowground, the snow sprays out via the opening. Therefore, the present snow scooter not only provides the brake function to the users but also simultaneously provides special visual effects to the viewers.

### BRIEF DESCRIPTION OF THE DRAWINGS

The present invention will now be specified with reference to its preferred embodiment illustrated in the drawings, in which

FIG. 1 shows a schematic view depicting a preferred embodiment of the present invention;

FIG. 2 shows a partially schematic view depicting the preferred embodiment of the present invention;

FIG. 3 shows a schematic bottom view depicting the preferred embodiment of the present invention;

FIG. 4 shows a schematic bottom view depicting guiding tracks being straightly extending from the middle of the front portion to the rear portion of the main board;

FIG. 5 shows a partially schematic view depicting flexible connecting members connected to the brake member to the rear portion of the main board;

FIG. 6 shows a partially enlarged view depicting the preferred embodiment of the present invention; and

FIG. 7 shows a schematic view depicting the preferred embodiment of the present invention how to expel snow.

### DESCRIPTION OF THE PREFERRED EMBODIMENT

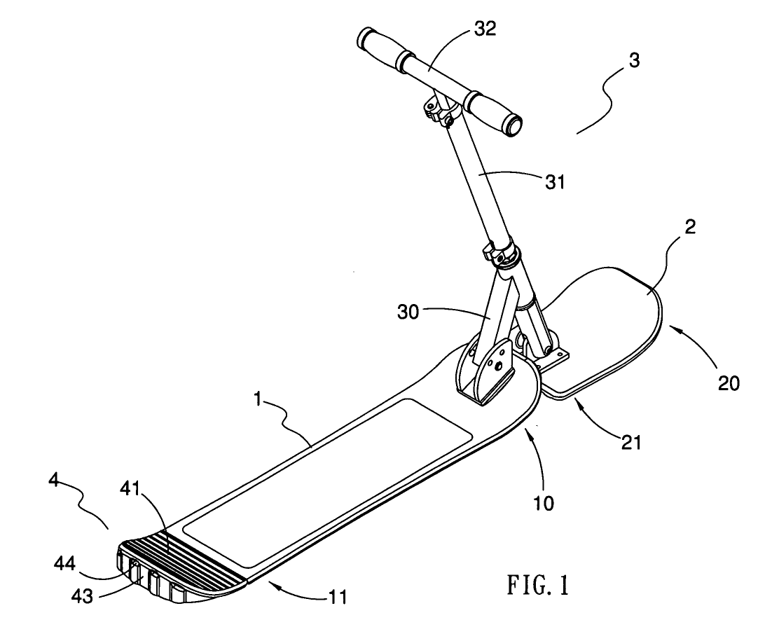

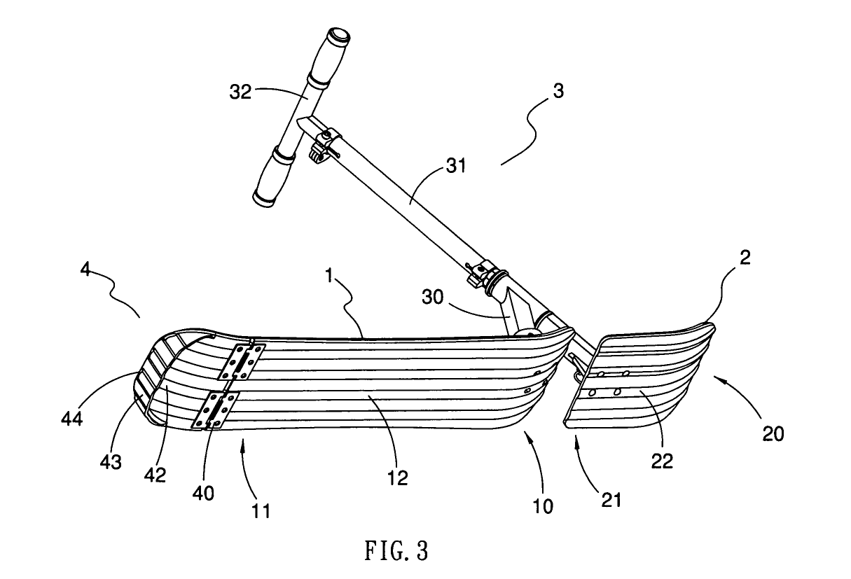

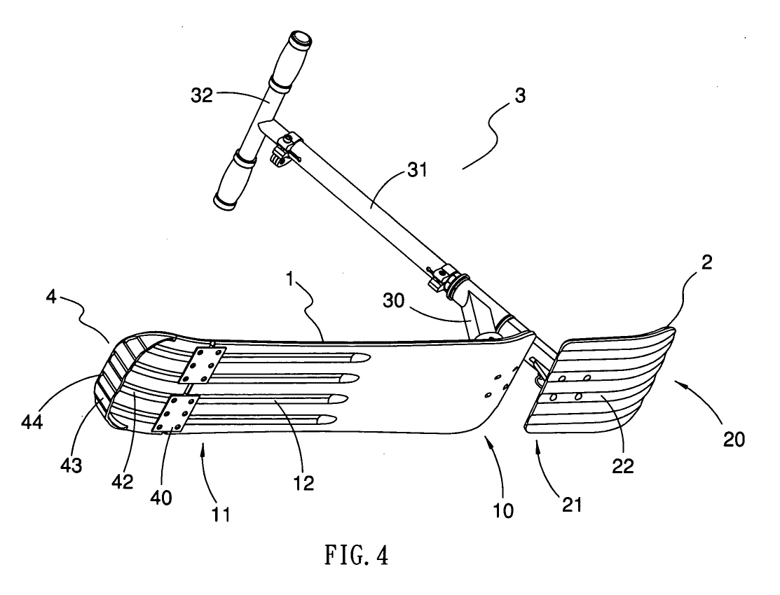

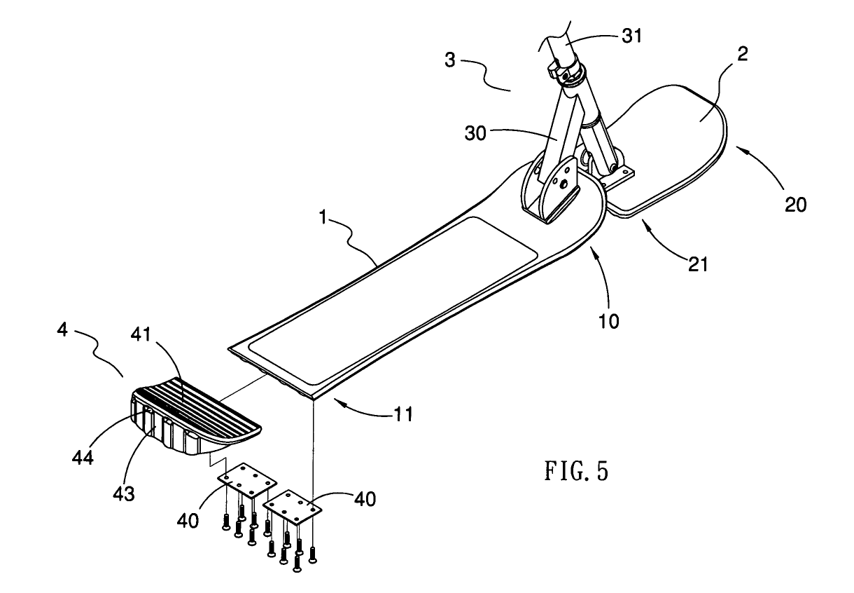

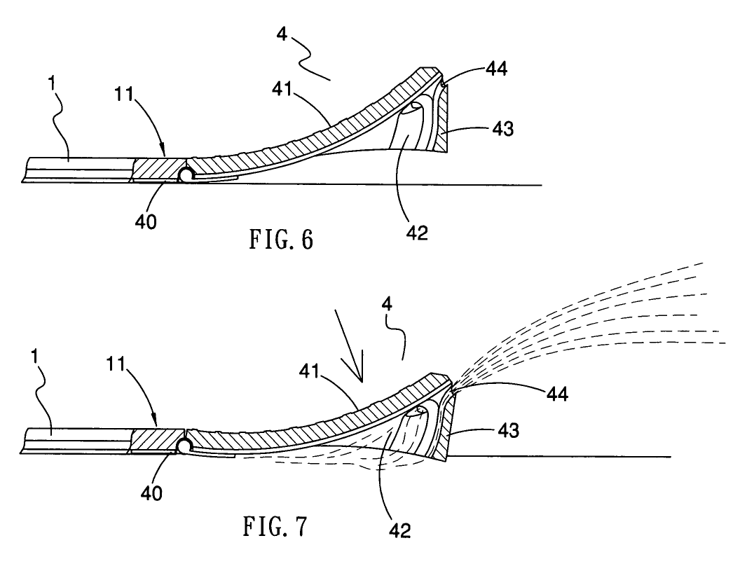

Please refer to FIG. 1 through FIG. 7, which respectively shows a snow scooter, as a preferred embodiment of the present invention. In FIG. 1, the snow scooter includes a main board 1, a front guiding board 2, a handlebar device 3 and a brake member 4. The main board is provided for a user standing thereon and has a front portion 10 and a rear portion 11. The front portion 10 is toward a sliding direction and raised to an angle with respect to the other portion of the main board 1. In addition, a plurality of guiding tracks 12 is formed on a bottom surface of the main board 1 and the guiding tracks 12 can be either straightly extending from the front portion 10 to the rear portion 11 or extending from the middle of the front portion to the rear portion of the main board, as show in FIG. 3 and FIG. 4. Furthermore, the shapes of the guiding tracks 12 in the present invention could be varied, such as in shapes protruding from the bottom surface of the main board 1 or in shapes recessing into the bottom surface of the main board 1. In this embodiment, the guiding tracks are preferred to recess into the bottom surface of the main board 1 respectively and parallel with each other.

In FIGS. 1-3, the front guiding board 2 is provided near the front portion 10 of the main board 1. The front guiding board 2 has a head end 20 and a tail end 21. The head end 20 of the front guiding board 2 is raised to an angle. In addition, the front guiding board 2 also has a plurality guiding tracks 22, which are formed on a bottom surface of the front guiding board 2 and extending straightly from the head end 20 to the tail end 21, similarly to the guiding tracks 12 of the main board 1.

The handlebar device 3 comprises a connecting joint 30, a stem 31 and a handlebar set 32. The connecting joint 30 has one end mounted on the front portion 10 of the main board 1 and the other end further extending beyond the main board 1. The stem 31 pivotally passes through the connecting joint 30 so as to rotate within the connecting joint 30. Furthermore, the handlebar set 32 is connected to a top end of the stem 31 for grabbing by hands. A bottom end of the stem 31 is provided for mounting to the front guiding board 2, which is aligned with the main board 1.

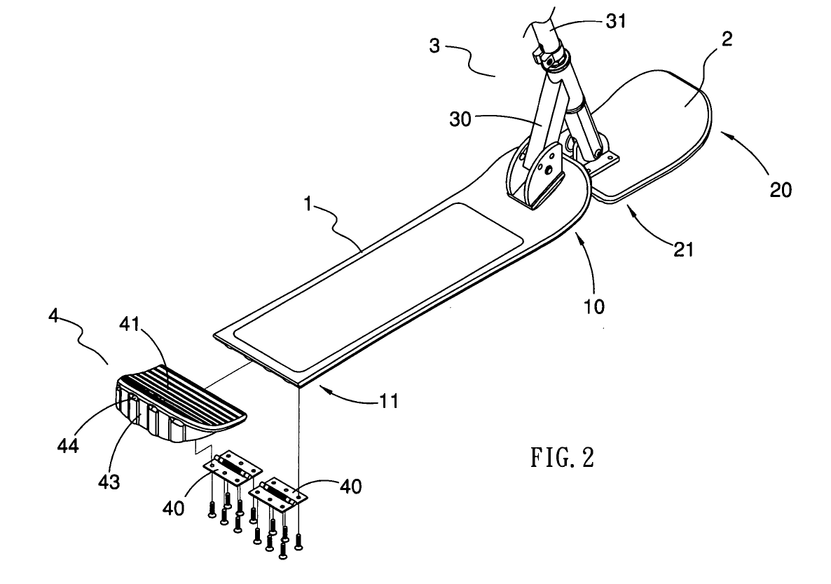

As FIGS. 2-5 shown, the brake member 4 is connected to the rear portion 11 of the main board 1 by two sets of flexible connecting members 40, such as flexible hinge members or flexible plate members; furthermore, the flexible plate members could be made of flexible materials, such as plastic, rubber or metal and the like. Therefore, the brake member 4 is movable and swingable to snowground and can return automatically to its original position while not operating the brake member 4. In addition, the brake member 4 has a shovel portion 43 formed under the brake member 4 and the shovel portion 43 has at least one opening 44 formed thereon for expelling the snow shoveled and gathered by the shovel portion 43 of the brake member 4. In this embodiment, the shovel portion 43 of the brake member 4 is preferred to be a curve board mounted on a bottom surface 42 of the brake member 4 and surrounded an edge of the bottom surface 42 of the brake member 4. Furthermore, the shovel portion 43 of the brake member is preferred to has an inner wall for guiding the shoveled snow to the opening 44 of the shoveled portion 43, as shown in FIG. 3-5 and the opening 44 of the shoveled portion 43 is preferred to be formed at the joint of the shovel portion 43. In present invention, the opening 44 not only could be formed on the shoveled portion 43, but also could be formed on any area of the brake member 4. Accordingly, more openings 44 are provided on the brake member 4, more snow is expelled.

FIG. 7 shows when a force is exerted onto a top surface 41 of the brake member 4, the brake member 4 swings downwardly and the shovel portion 43 of the brake member 4 shovels into snowground accordingly to generate resistance. Meanwhile, the shoveled and gathered snow is guided to and expelled from the opening 44 of the shovel portion 43. A rider could adjust the brake member 4 to decide a brake effect on the snowground by exerting a different force to the brake member 4. The greater angle of the brake member 4 swings, the greater resistance generates.

Furthermore, while operating the brake member 4, a certain amount of snow is gathered at the bottom surface 42 of the brake member 4 by the shovel portion 43 of the brake member 4. The inner wall of the shovel portion 43 therefore could guide the snow to the opening 44 of the shovel portion 43 and the snow is accordingly expelled through the opening 44. Greater amount of the snow is shoveled, greater snow is expelled. As a result, the expelled snow creates a spray effect to form a special curve of snow.

While the preferred embodiments of the present invention have been set forth for the purpose of disclosure, modifications of the disclosed embodiments of the present invention as well as other embodiments thereof may occur to those skilled in the art. Accordingly, the appended claims are intended to cover all embodiments which do not depart from the spirit and scope of the present invention.

1. A snow scooter, comprising:
a main board, having a front portion and a rear portion, the front portion being toward a sliding direction; and
a brake member, connected to the rear portion of the main board, the bake member being movable and swingable to snowground flexibly, wherein the brake member has at least one opening for expelling the snow.

2. A snow scooter, comprising:
a main board, having a front portion and a rear portion, the front portion being toward a sliding direction; and
a brake member, connected to the rear portion of the main board and being movable and swingable to snowground flexibly, wherein the brake member has a shovel portion formed under the brake member and the shovel portion of the brake member has at least one opening formed thereon for expelling the snow shoveled by the shovel portion.

3. The snow scooter according to claim 1, wherein a bottom surface of the main board further forms a plurality of guiding tracks, the guiding tracks being parallel with each other.

4. The snow scooter according to claim 2, wherein a bottom surface of the main board further forms a plurality of guiding tracks, the guiding tracks being parallel with each other.

5. The snow scooter according to claim 1, further comprises a flexible connecting member for connecting the brake member to the rear portion of the main board.

6. The snow scooter according to claim 2, further comprises a flexible connecting member for connecting the brake member to the rear portion of the main board.

7. The snow scooter according to claim 5, wherein the flexible connecting member is selected from one of the group consisting of plastic, rubber, and metal.

8. The snow scooter according to claim 6, wherein the flexible connecting member is selected from one of the group consisting of plastic, rubber, and metal.

9. The snow scooter according to claim 2, wherein the shovel portion is a curve board.

10. The snow scooter according to claim 1, further comprises:
a handlebar device, mounted to a top surface of the main board near the front portion of the main board for grabbing by hands.

11. The snow scooter according to claim 2, further comprises:
a handlebar device, mounted to a top surface of the main board near the front portion of the main board for grabbing by hands.

12. The snow scooter according to claim 10, wherein the handlebar device further comprises:
a connecting joint, mounted to the front portion of the main board and extending beyond the main board;
a stem, pivotally passing through the connecting joint;
a handlebar set, connected to a top end of the stem for grabbing by hands; and
a front guiding board, connected to a bottom end of the stem and aligned with the main board, wherein the front guiding board has a head end and a tail end.

13. The snow scooter according to claim 11, wherein the handlebar device further comprises:
a connecting joint, mounted to the front portion of the main board and extending beyond the main board;
a stem, pivotally passing through the connecting joint;
a handlebar set, connected to a top end of the stem for grabbing by hands; and
a front guiding board, connected to a bottom end of the stem and aligned with the main board, wherein the front guiding board has a head end and a tail end.

14. The snow scooter according to claim 12, wherein a bottom surface of the front guiding board further forms a plurality of guiding tracks straightly extending from the head end to the tail end of the front guiding board.

15. The snow scooter according to claim 13, wherein a bottom surface of the front guiding board further forms a plurality of guiding tracks straightly extending from the head end to the tail end of the front guiding board.
